(19) United States
(12) Patent Application Publication
(10) Pub. No.: US 2019/0236519 A1
(43) Pub. Date: Aug. 1, 2019

(54) COLLECTION AND DELIVERY SYSTEM AND INFORMATION PROCESSING APPARATUS

(71) Applicant: Toyota Jidosha Kabushiki Kaisha, Toyota-shi Aichi-ken (JP)

(72) Inventors: Yusuke Kaneko, Nagoya-shi Aichi-ken (JP); Masato Endo, Nagakute-shi Aichi-ken (JP); Shinji Sassa, Ama-shi Aichi-ken (JP); Takahiro Shiga, Chiryu-shi Aichi-ken (JP); Yohei Tanigawa, Toyota-shi Aichi-ken (JP)

(73) Assignee: Toyota Jidosha Kabushiki Kaisha, Toyota-shi Aichi-ken (JP)

(21) Appl. No.: 16/257,815

(22) Filed: Jan. 25, 2019

(30) Foreign Application Priority Data
Jan. 31, 2018 (JP) 2018-014450

(51) Int. Cl. G06Q 10/08; G05D 1/00

(52) U.S. Cl. CPC G06Q 10/083; G05D 2201/0216; G05D 1/0027; G05D 1/0088

(57) ABSTRACT

A collection and delivery system includes: autonomous mobile objects each configured to perform collection or delivery of a package, the autonomous mobile objects each including a loading portion, and an operation control unit configured to perform autonomous movement based on an operation instruction; and a server apparatus including circuitry configured to collect mobile object information that is information about the autonomous mobile objects, and generate the operation instruction. The circuitry is configured to determine whether, in a case where accumulation of packages loaded on a set of the autonomous mobile objects at one of the autonomous mobile objects in the set is performed, a specified condition is satisfied and to generate the operation instruction such that the set of the autonomous mobile objects performs the accumulation of the packages at a specified point when the specified condition is determined to be satisfied.

### CROSS-REFERENCE TO RELATED APPLICATIONS

This application claims priority to Japanese Patent Application No. 2018-014450 filed on Jan. 31, 2018, which is incorporated herein by reference in its entirety including the specification, drawings and abstract.

### BACKGROUND

### 1. Technical Field

The present disclosure relates to a collection and delivery system and information processing apparatus,

### 2. Description of Related Art

Study has been conducted on services using mobile objects that autonomously travel. For example, Japanese Patent No. 6164599 discloses a system for transporting a package to a specified delivery box by automatic operation and storing the package in the delivery box without human intervention.

### SUMMARY

While the system disclosed in Japanese Patent No. 664599 performs only package delivery, applying the system makes it possible to construct a. system that performs package collection with mobile objects that perform autonomous travel. However, unlike delivery, package collection is performed at any time based on a request from a user hence, if dedicated mobile objects are allocated, transport efficiency may be deteriorated, In other words, there is a room for enhancing utilization efficiency of the mobile objects.

The present disclosure provides a technique for enhancing the transport efficiency in a system that performs package collection and delivery with autonomous mobile objects.

A first aspect of the disclosure provides a collection and delivery system, including: a plurality of autonomous mobile objects each configured to perform at least one of collection and delivery of a package, the autonomous mobile objects each including, a loading portion in which the package is allowed to be loaded, and an operation control unit configured to perform autonomous movement based on an operation instruction; and a server apparatus including circuitry configured to collect mobile object information that is information about the autonomous mobile objects, and generate the operation instruction to the autonomous mobile objects. The circuitry is configured to determine whether, in a case where accumulation of packages loaded on a set of the autonomous mobile objects at one of the autonomous mobile objects in the set is performed, a specified condition is satisfied, the set of the autonomous mobile objects existing in a specified range and including two or more autonomous mobile objects included in the plurality of autonomous mobile objects, and to generate the operation instruction such that the set of the autonomous mobile objects performs the accumulation of the packages at a specified point when the specified condition is determined to be satisfied.

In the first aspect, the specified condition may be a condition related to a variation amount of a transportation cost varied by the accumulation of the packages.

The autonomous mobile objects are mobile objects that are configured to perform autonomous movement based on a specified operation instruction. The autonomous mobile objects are configured to be movable with packages, loaded thereon. The autonomous mobile objects are mainly designed to move on the roads. The autonomous mobile objects may be autonomous driving vehicles.

A server apparatus is an information processing apparatus that is configured to give an operation instruction to the autonomous mobile objects. The operation instruction may be information including, for example, information about a destination or a moving route, and information about services provided on the route. For example, the operation instruction may be defined as an instruction instructing transportation of a package based on a route or a destination, delivery or collection of a package at a specified location or the like. The operation instruction may be generated based on, for example, the current location of an intended autonomous mobile object, the status of the autonomous mobile object, a destination of a package for delivery, and a package collection request transmitted by a user.

The term “accumulation” may refer to transferring packages loaded on the autonomous mobile objects to one autonomous mobile object. By the accumulation, it may be possible to reduce the number of the autonomous mobile objects in operation. A first aspect can enhance the load efficiency of packages by the autonomous mobile objects and reduce a transportation cost.

In the first aspect, the circuitry may be configured to determine whether the specified condition is satisfied, based on mobile object information corresponding to the autonomous mobile objects in the set.

For example, the mobile object information may be information on a related autonomous mobile object, such as location information, a travel route, specifications (such as a load capacity and a luggage compartment size), a status (such as a state of charge and a travelable distance), information about loaded packages (such as the number, volume, and weight of the packages), and information about packages scheduled to be collected (such as collection destinations, the number, volume, and weight of the packages). However, the mobile object information is not limited to the above items. Whether or not it is appropriate to accumulate the packages may be determined based on the above information.

In the first aspect, the circuitry may be configured to determine that the specified condition is satisfied when all the autonomous mobile objects included in the set are destined to the same collection and delivery base.

When a plurality of autonomous mobile objects are traveling toward the same collection and delivery base (for example, a delivery center), the transportation cost can be reduced by accumulation of the packages.

In the first aspect, the circuitry may be configured to determine whether the specified condition is satisfied, based on a cost reduced by the accumulation of the packages and a cost increased by the accumulation of the packages.

When operation of one or more autonomous mobile objects can be ended by accumulation of the packages, the autonomous mobile objects that will end their operation can reduce the transportation cost. However, in some cases, the transportation cost may increase due to the autonomous mobile objects departing from a specified route in order to accumulate the packages. Therefore, by making, a comprehensive determination based on increased and reduced costs, the transportation cost can be further reduced.

In the first aspect, the circuitry may be configured to generate the operation instruction instructing package collection in accordance with a specified schedule or in response to a request from a user.

The correction may be performed by an autonomous mobile object configured to travel or to circuit in an area according to a specified schedule, and may be performed by an autonomous mobile object configured to travel in response to a request from a user.

In the above configuration, the circuitry may be configured to determine, based on an amount of packages loaded on an autonomous mobile object that performs the package collection, a fee corresponding to the package collection, and charge the fee to the user.

When package collection is performed in response to a request, the transportation efficiency changes with the load efficiency. Accordingly, it is possible to charge a package collection fee based on the amount (for example, the number, volume, weight, or the like) of the packages loaded on an intended autonomous mobile object. For example, when a package is collected at specified time, the load efficiency tends to become lower than when the package is collected at unspecified time. Hence, the package collection fee is set higher than in the case where the package efficiency is high. According to such, configuration, it becomes possible to set the collection fee in accordance with the transportation cost.

A second aspect of the disclosure provides an information processing apparatus, including circuitry configured to: collect information about a plurality of autonomous mobile objects each configured to perform at least one of collection and delivery of a package; generate an operation instruction to the autonomous mobile objects; determine whether, in a case where accumulation of packages loaded on a set of the autonomous mobile objects at one of the autonomous mobile objects in the set is performed, a specified condition is satisfied, the set of the autonomous mobile objects existing in a specified range and including two or more autonomous mobile objects included in the plurality of autonomous mobile objects; and generate the operation instruction such that the set of the autonomous mobile objects performs the accumulation of the packages at a specified point when the specified condition is determined to be satisfied.

In the second aspect, the specified condition may be a condition related to a variation amount of a transportation cost varied by the accumulation of the packages.

The aspects of the present disclosure can enhance the transportation efficiency in a system that performs package collection and delivery with autonomous mobile objects.

### BRIEF DESCRIPTION OF THE DRAWINGS

Features, advantages, and technical and industrial significance of exemplary embodiments of the disclosure will be described below with reference to the accompanying drawings, in which like numerals, denote like elements, and wherein:

FIG. 1 is a schematic diagram of a collection and delivery system according to a first embodiment;

FIG. 2 is a block diagram schematically showing examples of component members included in the collection and delivery system;

FIG. 3 is an external view of an autonomous travel vehicle 100;

FIG. 4 shows an example of operation instruction data generated by a server apparatus 200;

FIG. 5 is a flowchart showing data transferred between the component members of the system;

FIG. 6 is a flowchart of a process performed by the autonomous travel vehicle 100;

FIG. 7 is an explanatory view showing merging of the autonomous travel, vehicles 100;

FIG. 8A is an explanatory view showing merging of the autonomous travel vehicles 100;

FIG. 8B is an explanatory view showing merging of the autonomous travel vehicles 100; and

FIG. 9 is a flowchart of a process performed by an accumulation determination unit 2023.

### DETAILED DESCRIPTION OF EMBODIMENTS

### First Embodiment

System Overview

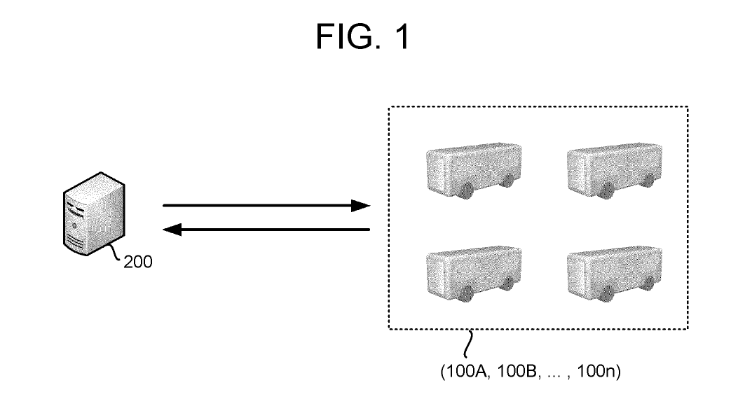

The overview of a collection and delivery system according to a first embodiment will be described with reference to FIG. 1. The collection and delivery system according to the present embodiment is configured by including a plurality of autonomous travel vehicles 100A, 100B, . . . , 100n that autonomously travel based on a given instruction, and a server apparatus 200 that issues the instruction. Hereinafter, the autonomous travel vehicles are simply referred to as the autonomous travel vehicle 100 when the vehicles, are collectively referred and not respectively identified. The autonomous travel vehicles 100 are automatic driving vehicles that provide transportation service. The server apparatus 200 is an apparatus that manages the autonomous travel vehicles 100.

The autonomous travel vehicles 100 are automatic driving vehicles that can travel with packages loaded thereon. The autonomous travel vehicles 100 are also called electric vehicle (EV) pallets. The autonomous travel vehicles 100 are not necessarily unmanned vehicles. For example, a staff such as an operating staff, a reception staff, and a security guard, may be aboard. The autonomous travel vehicles 100 may not necessarily be vehicles that can perform a completely autonomous travel. For example, the autonomous travel vehicles 100 may be vehicles that are driven by a person or that assist driving depending on situations. In the present embodiment, the autonomous travel vehicles 100 can travel based on a specified delivery destination or a collection destination, and can perform package delivery or collection.

The autonomous travel vehicles 100 may have functions to accept a request from a user, respond to the user, execute a specified process in response to the, request from the user, and report the result of the process to the user. Among the requests from users, those that cannot be processed by the autonomous travel vehicles 100 only may be transferred to the server apparatus 200, and be processed in cooperation with the server apparatus 200.

The server apparatus 200 is an apparatus that instructs operation of the autonomous travel, vehicles 100. For example, the server apparatus 200 generates an operation instruction instructing transportation of a package “from a collection base to a delivery destination” or “from a collection destination to a delivery base” based on information, about the package loaded on an intended autonomous travel vehicle 100 (for example, a delivery destination, time specification information, or the like), and information about a package to be collected (for example, a collection destination, time specification information, or the like). Thus, the autonomous travel vehicles 100 can perform package delivery and collection. The operation instruction is not limited to the instruction instructing traveling. For example, the operation instruction may instruct “to unload (deliver) a package at a specified point”, “to issue a receipt”, or the like. Thus, the operation instruction may include operations, other than traveling, to be performed by the autonomous travel vehicles 100. The autonomous travel vehicles 100 may execute the operations.

System Configuration

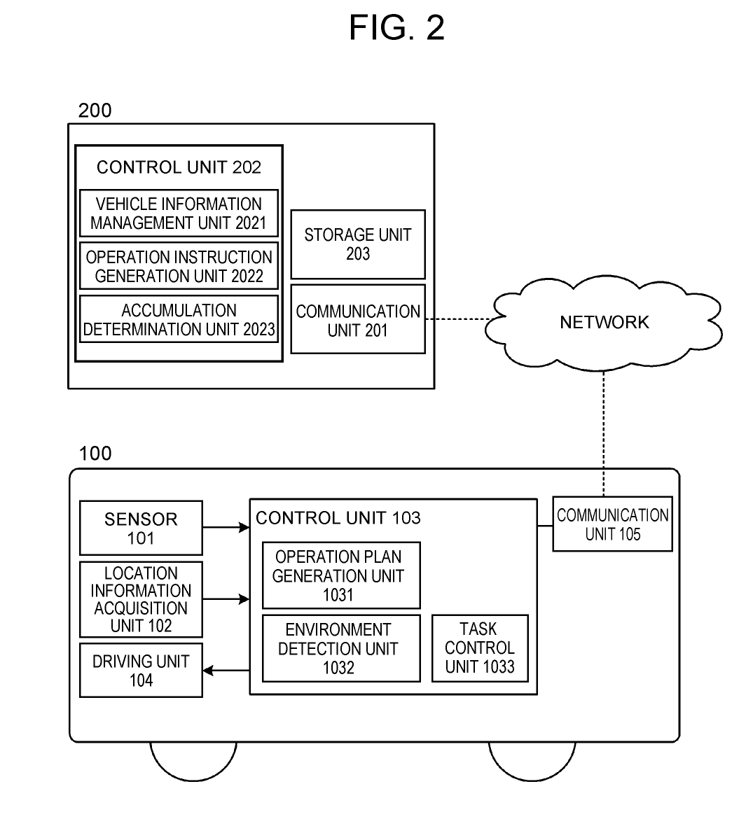

Component members of the system will be described in detail. FIG. 2 is a block diagram schematically showing one example of the configuration of the autonomous travel vehicle 100 and the server apparatus 200 shown in FIG. 1. Two or more autonomous travel vehicles 100 may be provided.

The autonomous travel vehicle 100 is a vehicle that travels in response to an operation instruction acquired from the server apparatus 200. Specifically, the autonomous travel vehicle 100 generates a travel route based on the operation instruction acquired via wireless communication, and travels on, a road by an appropriate method, while sensing the periphery of the vehicle.

The autonomous travel vehicle 100 is configured by including a sensor 101, a location information acquisition unit 102, a control unit 103, a driving unit 104, and a communication unit 105. The autonomous travel vehicle 100 operates with electric power supplied from an unillustrated battery.

The sensor 101 senses the periphery of the vehicle. The sensor 101 is typically configured by including a stereoscopic camera, a laser scanner, a LIDAR, a radar, and the like. The information acquired by the sensor 101 is transmitted to the control unit 103. The sensor 101 is configured by including a sensor for the own vehicle to perform an autonomous travel. The sensor 101 may also include a camera provided in a vehicle body of the autonomous travel vehicle 100. For example, the sensor 101 may include a photographing apparatus with use of an image sensor, such as a charged-coupled device (CCD), a metal-oxide-semiconductor (MOS), or a complementary metal-oxide-semiconductor (CMOS). A plurality of cameras may be provided in a plurality of portions of the vehicle body. For example, the cameras may be provided on the front side, the rear side, the right side, and the left side, respectively.

The location information acquisition unit 102 acquires the current location of the vehicle. The location information acquisition unit 102 is typically configured by including a GPS receiver, and the like. The information acquired by the location information acquisition unit 102 is transmitted to the control unit 103.

The control unit 103 is a computer that controls the autonomous travel vehicle 100 based on the information acquired from the sensor 101. The control unit 103 is constituted of a microcomputer, for example.

The control unit 103 has an operation plan generation unit 1031, an environment detection unit 1032, and a task control unit 1033 as functional modules. The functional modules may each be implemented by executing programs stored in a storage unit, such as a read only memory (ROM) (not illustrated), on a central processing unit (CPU) (not illustrated).

The operation plan generation unit 1031 acquires an operation instruction from the server apparatus 200, and generates an operation plan of the own vehicle. in the present embodiment, the operation plan is data that defines a travel route of the autonomous travel vehicle 100 and processes that the autonomous travel vehicle 100 should perform a part or the entirety of the route. Examples of the data included in the operation plan may include the following.

(1) Data Representing Route of Own Vehicle as Set of Road Links

For example, the travel route of the own vehicle may automatically be generated with reference to map data stored in an unshown storage unit, and based on given place of departure and destination. The travel route of the own vehicle may also be generated by using external service.

(2) Data Representing Processes That Should Be Performed by Own Vehicle at Points on Route

The processes that should be performed by the own vehicle on the route may include, for example, “deliver a specified package to a user”, “receive a package from a user”, and “accept a receipt or a claim check”. However, the processes are not limited to these. The operation plan. generated by the operation plan generation unit 1031 is transmitted to the later-described task control unit 1033.

The environment detection unit 1032 detects the environment around the vehicle based on the data acquired by the sensor 101. Examples of detection targets include the number and location of lanes, the number and location of the vehicles present around the own vehicle, the number and location of obstacles (for example, pedestrians, bicycles, structures, buildings, and the like) present around the own vehicle, the structure of roads, and road signs. However, the detection targets are not limited to these. The detection targets may be any objects as long as the objects are appropriate for autonomous traveling. The environment detection unit 1032 may track a detected object. For example, a relative speed of an object may be obtained from a difference between coordinates of the object detected one step before and the current coordinates of the object. The data about the environment (hereinafter, environment data) detected by the environment detection unit 1032 is transmitted to the later-described task control unit 1033.

The task control unit 1033 controls travel of the own vehicle based on the operation plan generated by the operation plan generation unit 1031, the environment data generated by the environment detection unit 1032, and the location information on the own vehicle acquired by the location information acquisition unit 102. For example, the task control unit 1033 makes the own vehicle travel along a specified route while preventing obstacles from entering into a specified safety area around the own vehicle. As a method for performing autonomous travel of the vehicle, a publicly-known method may be adopted. The task control unit 1033 may execute tasks (receiving a package from a user, issuing a receipt or a claim check, and the like) other than traveling, based on the operation plan the environment data generated by the environment detection unit 1032. the location information on the own vehicle acquired by the location information acquisition unit 102, or the like as appropriate) generated by the operation plan generation unit 1031.

The driving unit 104 makes the autonomous travel, vehicle 100 travel based on an instruction generated by the task control unit 1033. The driving unit 104 is configured by including, for example, a motor, an inverter, a brake, a steering mechanism, and a secondary battery for driving of wheels. The communication unit 105 connects the autonomous travel vehicle 100 to a network. In the present embodiment, the communication unit 105 can communicate with other apparatuses (for example, server apparatus 200) via a network with use of a mobile communications service, such as 3G and LTE. The communication unit 105 may further perform vehicle-to-vehicle communication with other autonomous travel vehicles 100.

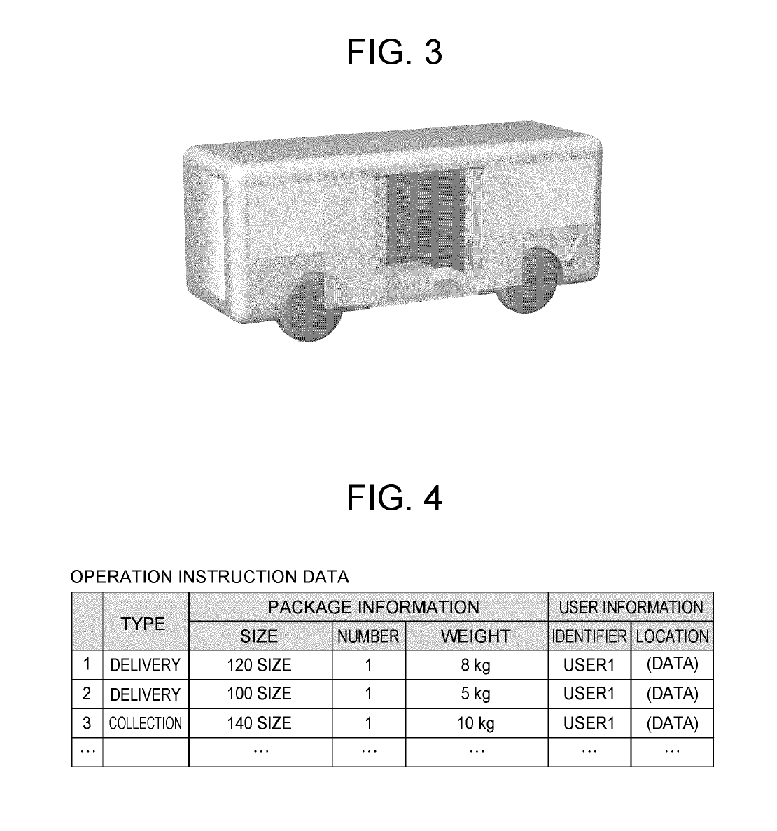

The autonomous travel vehicle 100 is configured, for loading packages. The autonomous travel vehicle 100 can load a package in a vehicle cabin as shown in FIG. 3. Although only one package is illustrated in the example of FIG. 3, the autonomous travel vehicle 100 is configured to be able to load a plurality of packages. The autonomous travel vehicle 100 may include a mechanism for delivering only a specified package among the plurality of packages. For example, the vehicle cabin may be equipped with a housing apparatus having a plurality of housing blocks, and only a permitted block may be unlocked. The autonomous travel vehicle 100 may also include a mechanism for delivering the loaded packages to other apparatuses. For example, the autonomous travel vehicle 100 may include a mechanism that is connected with other housing apparatuses, such as home-delivery lockers, to transfer a package thereto. The autonomous travel vehicle 100 may also include a mechanism for package delivery between the autonomous travel vehicle 100 and an autonomous mobile object (personal assistant robot) managed by a user. The autonomous travel vehicle 100 may also include a device that issues a receipt or a claim check. These functions are controlled by the task control unit 1033.

Description is now given of the server apparatus 200. The server apparatus 200 is an apparatus that manages the location and state of the autonomous travel vehicles 100, and transmits an operation instruction. For example, when receiving a collection request from a user, the server apparatus 200 first acquires the location to collect a package, and then transmits an operation instruction to the autonomous travel vehicle 100 (capable of collecting the package) that is traveling in the vicinity of the location.

The server apparatus 200 is configured by having a communication unit 201, a control unit 202, and a storage unit 203. The communication unit 201 is a communication interface, similar to the communication unit 105. for communication with the autonomous travel vehicles 100 via a network.

The control unit 202 controls the server apparatus 200. The control unit 202 is constituted of a CPU, for example. The control unit 202 has a vehicle information management unit 2021, an operation instruction generation unit 2022, and an accumulation determination unit 2.023 as functional modules. The functional modules may each be implemented by executing programs stored in a storage unit, such as a ROM (not illustrated), on the CPU (not illustrated).

The vehicle information management unit 2021 manages the autonomous travel vehicles 100 under management. Specifically, the vehicle information management unit 2021 receives from the autonomous travel, vehicles 100 data (mobile object information in the present disclosure) about each of the autonomous travel vehicles 100 in every specified period, and stores the received data in the later-described storage unit 203. In the present embodiment, location information and vehicle information are used as the data about the autonomous travel vehicles 100. Examples of the vehicle information include an identifier, application and type, information about a waiting point (garage or service office), a door type, a body size, a luggage compartment size, a load capacity, a travelable distance when fully-charged, a travelable distance at present time, and current status (the amount, weight, and volume of packages currently loaded, the amount, weight, volume, and collection destination of packages to be collected, or the like) of each of the autonomous travel vehicles 100. However, the vehicle information may be other than these.

When receiving an operation request of the autonomous travel vehicles 100, the operation instruction generation unit 2022 determines which autonomous travel vehicle 100 to send, and generates an operation instruction corresponding to the operation request. Stated below are examples of the operation request. However, the operation request may be other than the requests stated below (1) Request for package delivery: this is a request for delivering a package or packages to a user. The request may include information about the number, size, weight, and delivery destination of the packages. (2) Request for package collection: this is a request for collecting a package or packages from a user. The request may include information about the number, size, weight, and collection destination of the packages.

For example, in the case of package delivery, the operation request may be issued by an administrator of the system or a forwarder. In the case of package collection, the operation request may be acquired from a user via a network or the like. Even in the case of package collection, the operation request may be issued by the administrator of the system or the forwarder. In the following description, an entity that issues a request is collectively called “user”.

FIG. 4 shows the operation instruction generated based on these pieces of information. The operation instruction is constituted of a type (delivery or collection), package information, and user information. The package information represents the size, the number, and weight of packages to be delivered or collected. The package information may have other formats as long as the information can be used to determine whether or not packages are loadable onto the autonomous travel vehicle 100. The user information includes information to identify a user, and the location to deliver or collect packages.

The autonomous travel vehicle 100 to which the operation instruction is transmitted is determined in accordance with information, such as the location information and the vehicle information (indicative of whether or not the vehicle can execute the task of delivery or collection) acquired by the vehicle information management unit 2021. When the operation request is a collection request, the determined autonomous travel vehicle 100 may be sent out immediately, or may wait for a specified period in order to receive a plurality of collection requests.

The accumulation determination unit 2023 determines whether or not to accumulate the packages loaded on the autonomous travel vehicles 100 in operation. When it is determined to accumulate the packages, the accumulation determination unit 2023 generates routes for merging the respective autonomous travel vehicles 100. The term “accumulation” refers to transferring packages loaded on the autonomous travel vehicles 100 to one autonomous travel vehicle 100 in order to reduce the number of the autonomous travel vehicles 100 in operation. Detailed determination method and generation method of the routes will be described later.

The storage unit 203, which stores information, is constituted of a storage medium, such as a RAM, a magnetic disk, and a flash memory.

Operation Work Based on Operation Instruction

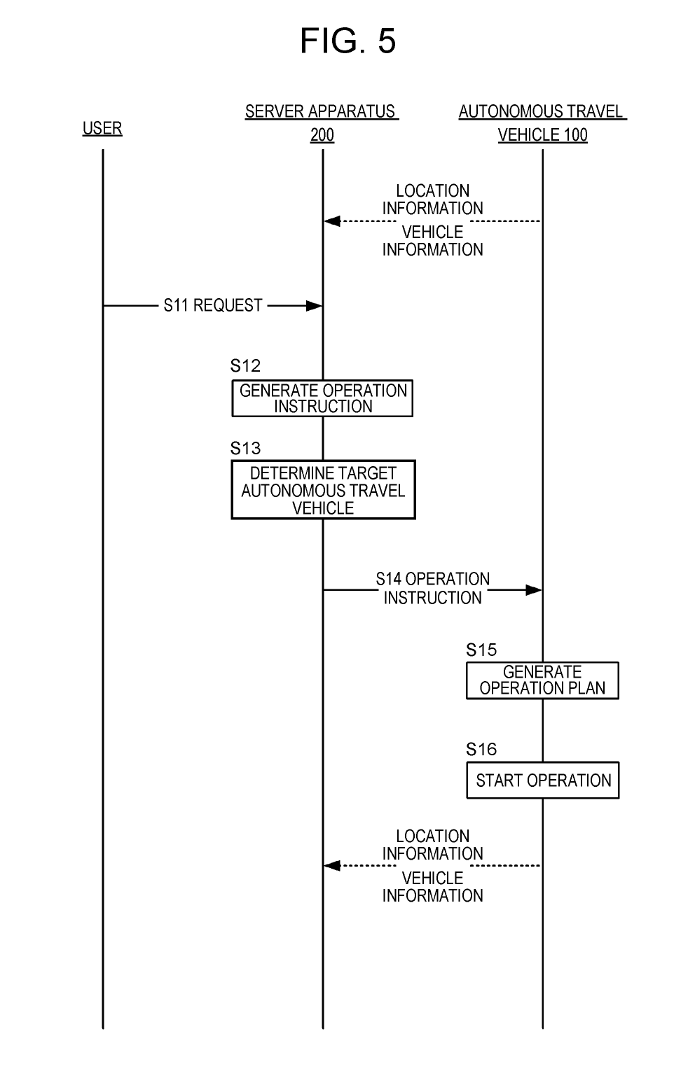

The processes performed by the component members described before will be described. FIG. 5 is an explanatory view of a data flow from the time when the server apparatus 200 generates an operation instruction based on a request acquired from the user to the time when the autonomous travel vehicle 100 starts operation.

The autonomous travel vehicle 100 periodically transmits location information to the server apparatus 200. For example, the location information may be information that identifies a node and a link, when a road network is defined by nodes and links. The location information, may also be a latitude, a longitude, or the like. The vehicle information management unit 2021 stores the received location information in association with the autonomous travel vehicle 100 in the storage unit 203. Whenever the autonomous travel vehicle 100 moves, the location information is updated.

The autonomous travel vehicle 100 also periodically transmits the vehicle information to the server apparatus 200. In the present embodiment, the autonomous travel vehicle 100 transmits the following information as the vehicle information. Among the information illustrated below, repeated transmission of the information peculiar to the autonomous travel vehicle 100 may be omitted. The information includes: information about the capacity of the own vehicle (the loadable size, loadable weight, and loadable number of packages, or the like); the number of packages currently loaded; the volume of packages currently loaded; the weight of the packages currently loaded; current battery state of charge (SOC); travelable distance; information about an operation route (when the vehicle is in operation); information about packages scheduled to be increased on an operation route (the number, volume, and weight of packages, collection points, or the like); and information about packages scheduled to be decreased on an operation route (the number, volume, and weight of packages, delivery points, or the like)

When a user transmits a request (a delivery request or a collection request) to the server apparatus 200 via an unshown communication unit (step S11), the server apparatus 200 (operation instruction generation unit 2022) generates an operation instruction in response to the request (step S12).

In step S13, the operation instruction generation unit 202.2 selects an autonomous travel vehicle 100 that provides service. For example, the operation instruction generation unit 2022 determines the autonomous travel vehicle 100 that can provide the requested service, with reference to the stored location information and vehicle information of the autonomous travel vehicles 100. In step S14, an operation instruction is transmitted to the target autonomous travel vehicle 100 from the server apparatus 200.

In step S15, the determined target autonomous travel vehicle 100 (operation plan generation unit 1031) generates an operation plan based on the received operation instruction. For example, the autonomous travel vehicle 100 generates an operation plan for identifying a travel route, a point to deliver a package on the travel route, a point to receive a package on the route, and the like, performing package delivery task and collection task, and then returning to a specified location (for example, delivery center).

The generated operation plan is transmitted to the task control unit 1033, and operation is started (step S16). Transmission of the location information and the vehicle information to the server apparatus 200 is periodically performed while the autonomous travel vehicle 100 is in operation.

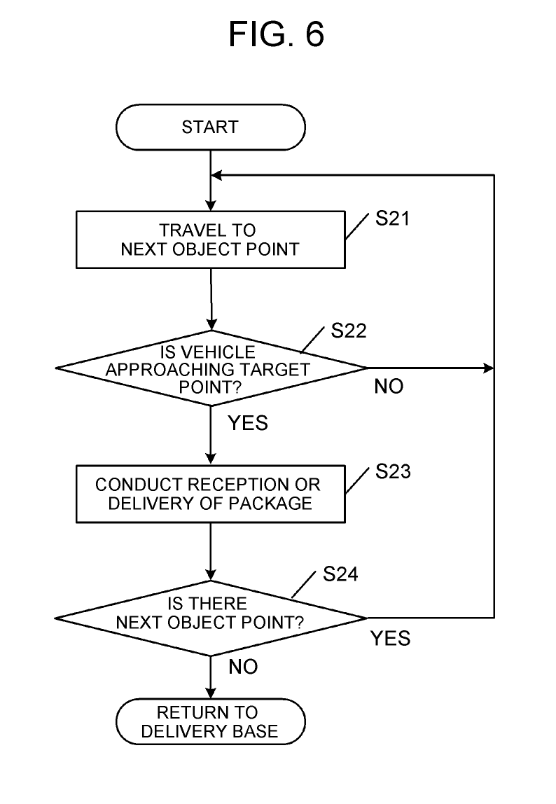

FIG. 6 is a flowchart of the process performed by the autonomous travel vehicle 100 after the start of operation in step S16. First, in step S21, the task control unit 1033 makes the autonomous travel vehicle 100 start traveling to a next object point (a delivery point or a collection point) based on the generated operation plan. When the autonomous travel vehicle 100 approaches the target point (step S22), the task control unit 1033 searches for a location where the vehicle can be stopped in the vicinity of the target point, stops the autonomous travel vehicle 100 at the searched location, and executes package reception or delivery (step S23). The package reception, may be performed by summoning the user by transmitting, a message to a mobile terminal possessed by the user. When a delivery box or the like is provided in the target point, the package reception may automatically be performed (by using the technique disclosed in Japanese Patent No. 6164599, or the like). A small mobile object that autonomously moves may further be loaded on the autonomous travel vehicle 100, and the small mobile object may transport the package.

Next, the task control unit 1033 determines the presence of a next object point (a delivery point or a collection point) based on the operation plan (step S24). When there is the next target point, the task control unit 1033 continues the operation of the autonomous travel vehicle 100. When there is no next object point, the autonomous travel vehicle 100 returns to the collection and delivery base.

Package Accumulation Process

Next, a package accumulation process will be described. When packages are transported (collected in particular) by the aforementioned method, the autonomous travel vehicles 100 may go to the same destination. For example, there may be a ease where two autonomous travel vehicles 100 collect packages at locations different from each other, and head for the same collection and delivery base (delivery center). However, in such a case, the transportation cost for two autonomous travel vehicles 100 is accrued.

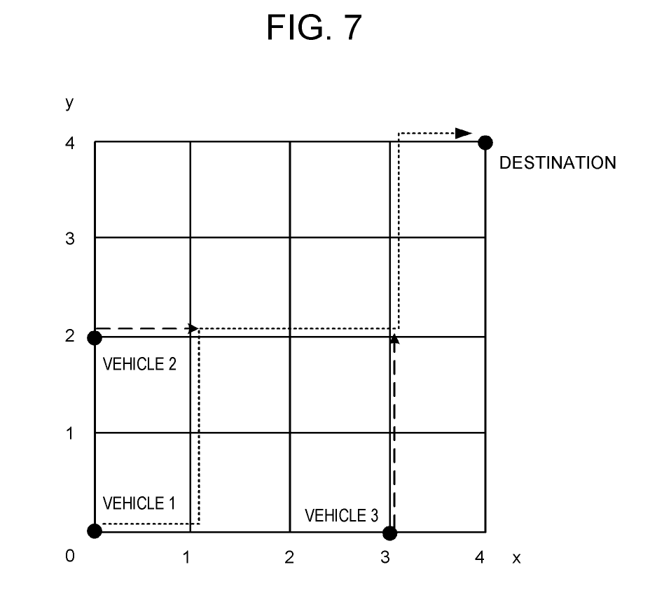

Accordingly, in the present embodiment, the server apparatus 200 analyzes the states of the autonomous travel vehicles 100, and determines whether to perform package accumulation. Based on the determination, the server apparatus 200 merges the autonomous travel vehicles 100 to accumulate the packages. Merging of vehicles will briefly be described. FIG. 7 shows the autonomous travel vehicles 100 traveling toward the destination. A vehicle 1 travels from coordinates (0, 0), a vehicle 2 travels from coordinates (0, 2), and a vehicle 3 travels from coordinates (3, 0) to coordinates (4, 4) that is a destination. At this time, if the vehicles independently head for the destination, the vehicle 1 would travel a distance of eight blocks, the vehicle 2 would travel a distance of six blocks, and the vehicle 3 would travel a distance of five blocks. In contrast, when the travel route of the vehicle 1 is set as shown with a broken line, and the travel routes of the vehicle 2 and the vehicle 3 are set as shown with a dotted line, the vehicle 2 can merge at coordinates (1, 2), and the vehicle 3 can merge at coordinates (3, 2). When packages are transferred at the merging points, and operation of the vehicles 2, 3 is terminated, the total travel distance of the vehicles becomes eleven blocks, as the distance of the vehicle 1 is eight, the distance of the vehicle 2 is one, and the distance of the vehicle 3 is two. As compared with the case where the vehicles independently travel (8+6+5=19 blocks), the total movement cost for eight blocks can be saved (transportation of the vehicles is not taken into consideration here). The server apparatus 200 according to the present embodiment determines whether or not to merge the autonomous travel vehicles 100 by such a method, and generates an operation instruction instructing merging and package accumulation based on the determination,

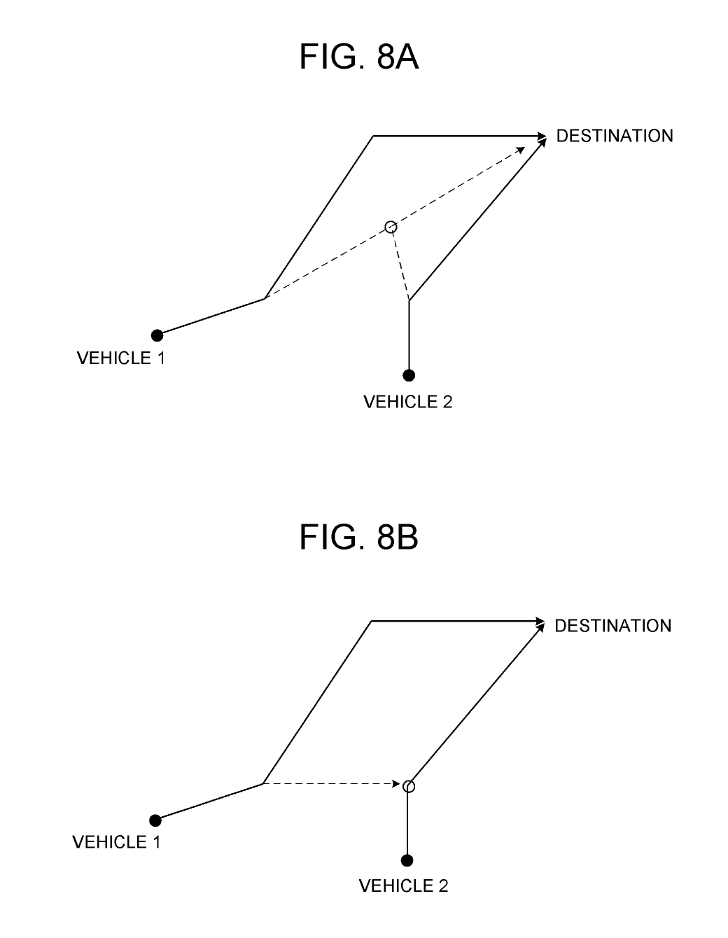

There are two modes of merging of vehicles, Each mode will be described with reference to FIGS. 8A and 8B. FIGS. 8A and 8B show a shortest route in the case where two vehicles individually head for the destination, with a solid line. The term “shortest route” used in description of the embodiments does not necessarily mean the route shortest in distance. Rather, the term refers to the route lowest in movement cost when the distance or time is converted into a movement cost. FIG. 8A shows a mode in which the vehicle 1 and the vehicle 2 change their routes, and merge. When this method is adopted, points (hereinafter referred to as departure points) where the two vehicles deviate from their original routes are determined, and a point (hereinafter referred to as a merging point) where the two vehicles merge is determined. FIG 8B shows a mode in which one vehicle departs from its original route and heads for the route of the other vehicle. In this mode, the vehicle 2 does not need to change the route. When this mode is adopted, the departure point of the vehicle 1 is determined, and the merging point of the two vehicles is determined. One of the two modes described above may be used, or both the modes may be used to execute the process, and then one mode, which can reduce the total cost more, may be selected.

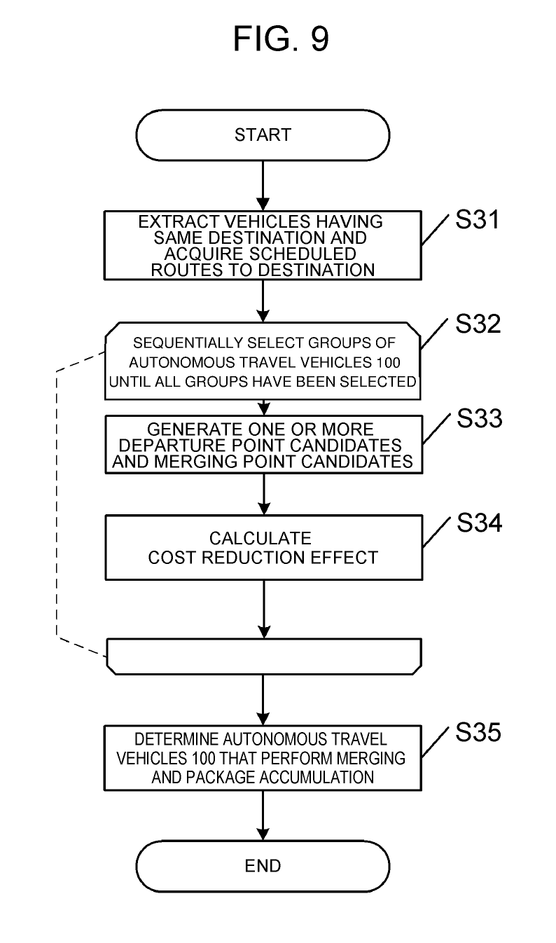

Determination of whether to perform package accumulation may periodically be executed by the accumulation determination unit 2023. FIG. 9 is a flowchart of a process performed by the accumulation determination unit 2023. First, in step 531, the accumulation determination unit 2023 extracts the autonomous travel vehicles 100 having the same destination based on the collected vehicle information, and acquires information about the scheduled route of each vehicle. In some embodiments, the autonomous travel vehicles 100 are extracted from a specified area. When the vehicles are too distanced from each other, the cost reduction effect by package accumulation deteriorates.

Next, in step S32, the accumulation determination unit 2023 sequentially selects groups of the autonomous travel vehicles 100 included within a specified range. The process of steps S33 to S34 is performed on the selected groups. Each group may be made up of two vehicles, or three or more vehicles.

In step S33, the accumulation determination unit 2023 generates candidates of a point (departure point candidates) where each vehicle departs from its original route, and candidates of a point (merging point candidates) where each vehicle merges. Since there are a plurality of pairs of the departure point candidate and the merging point candidate, the candidates may be selected based on a specified reference. For example, the pair that minimizes the movement cost required for merging may be selected. In step S33, one pair of the points may be generated, or two or more pairs may be generated in step S33.

Next, in step S34, the cost reduction effect in the case where the autonomous travel vehicles 100 merge and perform package accumulation based on the selected pair is calculated. Here, an estimated reduction amount of the movement cost is quantized, for example. The movement cost reduction amount may be, for example, a value indicating a reduction level in the traveling time, travel distance, total electric power consumption required for traveling, or the like. Here, the cost reduction elect may be calculated in consideration of a cost added for merging. When there is any autonomous travel vehicle 100 that is out of packages due to package accumulation, and the pertinent autonomous travel vehicle 100 can perform another task, the task may be taken into consideration. The cost reduction amount is calculable based on the vehicle information corresponding to each of the autonomous travel vehicles 100.

When the process of steps S32 to S34 is completed, the cost reduction amount obtained when package accumulation is performed is calculated for every group of the autonomous travel vehicles 100. In step S35, the accumulation determination unit 2023 determines one group of the autonomous travel vehicles 100 that performs merging and package accumulation based on the calculated cost reduction amount. For example, when the calculated cost reduction amount exceeds a specified value, the accumulation determination unit 2023 may determine to perform merging and package accumulation. The determined group of the determined autonomous travel vehicles 100, and the determined departure point candidate and merging point candidate are transmitted to the operation instruction generation unit 2022, where an operation instruction (second operation instruction) for merging and package accumulation is generated. The second operation instruction is transmitted to the target autonomous travel vehicles 100, and the target autonomous travel vehicles 100 operate in response to the second operation instruction. The second operation instruction may overwrite the original operation instruction, or may correct the original operation instruction.

As described above, in the system that performs package collection and delivery with the autonomous travel vehicles 100, the first embodiment can enhance the load capacity per vehicle, and reduce the cost required for operation.

### Second Embodiment

In the first embodiment, when there is an operation request, the server apparatus 200 generates an operation instruction. The second embodiment encompasses the configuration of the first embodiment, and is further configured to use some autonomous travel vehicles 100 configured to travel in an area according to a specified schedule so as to pick up packages any time in response to a collection request.

In addition to the configuration of the first embodiment, the second embodiment is configured such that the server apparatus 200 generates an operation instruction instructing “to travel in an area according to a specified schedule to pick up packages in response to a collection request”, and some autonomous travel vehicles 100 that operate in accordance with the operation instruction are used. Such autonomous travel vehicles 100 are referred to as circuit vehicles. The circuit vehicles may suitably be selected by the server apparatus 200. The circuit vehicles may periodically drop in at the collection and delivery base during circuit, or may return to the collection and delivery base when the loaded packages exceed a specified amount.

In the second embodiment, when the server apparatus 200 acquires a collection request, the user can select, with unshown input-output functions, whether to get an available autonomous travel vehicle 100 to immediately go to the user or to use an available circuit vehicle for package collection. In the case of using the circuit vehicle, the operation instruction generation unit 2022 generates an additional operation instruction indicative of the contents of collection, and transmits the operation instruction to the circuit vehicle. In accordance with the additional operation instruction, the circuit vehicle drops in on the user during operation to perform package collection. When the user does not use the circuit vehicle, an autonomous travel vehicle 100 dedicated to package collection heads for package collection as in the first embodiment.

In the second embodiment, the server apparatus 200 further has a payment function (unshown) for charging a collection fee to the user. The payment function settles the collection fee by using settlement information associated with the user (for example, credit card information, or the like). The collection fee charged in the second embodiment varies in accordance with the amount of the packages loaded on the autonomous travel vehicle 100 that goes to package collection. For example, when the autonomous travel vehicle 100 immediately goes to package collection, the load capacity becomes smaller than usual, so that an operation, cost per package increases. Hence, a higher collection fee is set. When package collection is performed with the circuit vehicle, the circuit vehicle can drop in at more collection destinations (i.e., load more packages), so that the operation cost per package decreases. Hence, a lower collection fee is set.

The load capacity, used as a reference for calculating the collection fee, may be defined as the amount of packages loadable on the autonomous travel vehicle 100 in one operation, for example. The amount of packages loadable on the autonomous travel vehicle 100 may be predicted based on, for example, the vehicle information collected by the server apparatus 200, and the collection requests stored in the server apparatus 200. The amount of packages is not limited to the number of packages. The amount of packages may be determined based on the volume, weight, transportation fees, or the like, of the packages. The determined collection fee may be presented to the user when a collection request of the user is acquired.

As described in the foregoing, the second embodiment can enhance the load capacity per vehicle by determining the collection fee based on the load capacity of packages.

Modifications

The aforementioned embodiments are merely examples, and modifications of the present disclosure are suitably possible without departing from the scope of the present disclosure. For example, in the aforementioned embodiments, the cost reduction effect in the case where the autonomous travel vehicles 100 merge to perform package accumulation is calculated, and a group of the autonomous travel vehicles 100 that performs merging and package accumulation is determined based on the calculated cost reduction amount. However, in other embodiments, the group of the autonomous travel vehicles 100 that performs merging and package accumulation may be determined, for example, based on whether or not there is any autonomous travel vehicle 100 that is out of packages due to package accumulation. That is, when there is any autonomous travel vehicle 100 that is out of packages due to package accumulation in the group of the autonomous travel vehicles 100, it may be determined that merging and package accumulation is performed. When there is no autonomous travel vehicle 100 that is out of packages due to package accumulation, it may be determined that merging and package accumulation is not performed.

In the description of the embodiments, package accumulation is performed when the autonomous travel vehicles 100 head for the same collection and delivery base. However, package accumulation may be performed under other conditions, when transportation cost is reduced by package accumulation. For example, when the autonomous travel vehicles 100 circulate a specified area for the purpose of package collection and delivery, the autonomous travel vehicles 100 may merge to perform package accumulation.

What is claimed is:

1. A collection and delivery system, comprising:
a plurality of autonomous mobile objects each configured to perform at least one of collection and delivery of a package, the autonomous mobile objects each including
a loading portion in which the package is allowed to be loaded, and
an operation control unit configured to perform autonomous movement based on an operation instruction; and
a server apparatus including circuitry configured to
collect mobile object information that is information about the autonomous mobile objects, and
generate the operation instruction to the autonomous mobile objects, wherein the circuitry is configured
to determine whether, in a case where accumulation of packages loaded on a set of the autonomous mobile objects at one of the autonomous mobile objects in the set is performed, a specified condition is satisfied, the set of the autonomous mobile objects existing in a specified range and including two or more autonomous mobile objects included in the plurality of autonomous mobile objects, and
to generate the operation instruction such that the set of the autonomous mobile objects per the accumulation of the packages at a specified point when the specified condition is determined to be satisfied.

2. The collection and delivery system according to claim 1, wherein
the specified condition is a condition related to a variation amount of a transportation cost varied by the accumulation of the packages.

3. The collection and delivery system according to claim 2, wherein
the circuitry is configured to determine whether the specified condition is satisfied, based on mobile object information corresponding to the autonomous mobile objects in the set.

4. The collection and delivery system according to claim 1, wherein
the circuitry is configured to determine that the specified condition is satisfied when all the autonomous mobile objects included in the set are destined to the same collection and delivery base.

5. The collection and delivery system according to claim 2, wherein
the circuitry is configured to determine whether the specified condition is satisfied, based on a cost reduced by the accumulation of the packages and a cost increased by the accumulation of the packages.

6. The collection and deliver) system according to claim 2, wherein
the circuitry is configured to generate the operation instruction instructing package collection in accordance with a specified schedule or in response to a request from a user.

7. The collection and delivery system according to claim 6, wherein
the circuitry is configured to determine, based on an amount of packages loaded on an autonomous mobile object that performs the, package collection, a fee corresponding to the package collection, and charge the fee to the user.

8. An information processing apparatus, comprising circuitry configured to:
collect information about a plurality of autonomous mobile objects each configured to perform at least one of collection and delivery of a package;
generate an operation instruction to the autonomous mobile objects;
determine whether; in a case where accumulation of packages loaded on a set of the autonomous mobile objects at one of the autonomous mobile objects in the set is performed, a specified condition is satisfied, the set of the autonomous mobile objects existing in a specified lunge and including two or more autonomous mobile objects included in the plurality of autonomous mobile objects; and
generate the operation instruction such that the set of the autonomous mobile objects performs the accumulation of the packages at a specified point when the specified condition is determined to be satisfied.

9. The information processing apparatus according to claim 8, wherein
the specified condition is a condition related to a variation amount of a transportation cost varied by the accumulation of the packages.
